(19) United States
(12) Patent Application Publication
(10) Pub. No.: US 2008/0077416 A1
(43) Pub. Date: Mar. 27, 2008

(54) Method and apparatus for managing virtual team collaboration meetings

(76) Inventor: William A. Hetrick, Wichita, KS (US)

Correspondence Address: LSI CORPORATION, 1621 BARBER LANE, MS: D-106, MILPITAS, CA, 95035, US

(21) Appl. No.: 11/527,153

(22) Filed: Sep. 26, 2006

(51) Int. Cl. G06Q 10/00; G06Q 30/00

(52) U.S. Cl. 705/1

(57) ABSTRACT

The present invention is directed to a method and apparatus for managing virtual team collaboration meetings. Team members enter answers to scrum questions into a virtual scrum tool, subject to user-defined answer length restrictions, at the beginning of their work day. The virtual scrum tool sends reminders to team members if scrum answers are not submitted a within user-defined time frame. The virtual scrum tool sends brief notifications to registered team members when a team member updates scrum answers. The virtual scrum tool stores scrum answers and provides browsing access to the stored scrum answers and RSS feeds of team member's latest scrum answers.

### FIELD OF THE INVENTION

This invention relates generally to collaboration software, and particularly to a method and apparatus for managing virtual team collaboration meetings.

### BACKGROUND OF THE INVENTION

Agile software development is a conceptual framework for undertaking software engineering projects. Agile software development methods focus on adapting quickly to changing requirements. Agile software development is particularly suitable when requirements are emergent and rapidly changing.

Communication is one of the first tenets of Agile software development processes. One of the project management practices that teams find very helpful is a daily “scrum”. A “scrum” is a brief meeting at the beginning of the day (a brief daily check-in) where each person on the project answers three questions:

What did I do yesterday?

What do I plan to do today?

What is impeding progress?

With these simple, brief statements a person's progress, objectives, and concerns can be quickly communicated. These questions generally provide adequate detail to establish expectations, create accountability, communicate distractions, and raise schedule or risk issues. The scrum meeting is not a forum to solve problems. If someone else within the team has ideas on how to help, the individuals meet outside of the scrum huddle to work through the issues. Ideally, this means face-to-face, co-located teams. However, in larger development organizations, co-located teams have become a luxury and not the norm.

Conventional approaches to this problem include conference calls, individual emails, and blogs. These approaches have significant drawbacks. Holding scrum meetings by conference call still requires the team to meet at a common point in time. This is an issue for teams with wide time zone differences (e.g. United States and Europe or United States and India). Individuals on a team can email answers to the questions to each other, but this haphazard approach distributes storage of check-in entries to the email recipients. Blogs are too free-form. They allow entries to become too long, which runs counter to the principle of the brief daily check-in.

Thus, it would be desirable to provide a low transaction cost method for teams to answer the scrum questions and receive scrum information from team members where a common scrum meeting time and location are not feasible due to geographic constraints or disparate work schedules. It would also be desirable to be able to manage how team members answered scrum questions to conform to brevity and timing requirements.

### SUMMARY OF THE INVENTION

Accordingly, the present invention may provide a low transaction cost method for teams to answer scrum questions and receive scrum information from team members where a common scrum meeting time and location are not feasible due to geographic constraints or disparate work schedules.

Additionally, the present invention may allow management of how team members answered scrum questions to conform to brevity and timing requirements

In an exemplary aspect of the present invention, a method for managing virtual team collaboration meetings includes steps as follows. A team member enters answers to the scrum questions, subject to user-defined answer length restrictions. A reminder is sent to a team member if scrum answers are not submitted a within user-defined time frame. A brief notification is sent to registered team members when a team member updates scrum answers. Scrum answers are stored and browsing access is provided to the stored scrum answers. RSS (a web feed format used for Web syndication) feeds are also provided of team member's latest scrum answers.

Team members submit their answers to scrum questions at the beginning of their day-in their time zone, in their work schedule. Brief answers are enforced by limiting the number of characters allowed. If team members neglect to submit their answers to scrum questions they are reminded to do so. When team members submit their scrum answers, emails are sent to the set of registered email addresses to notify interested parties. Collaboration and accountability within the team is increased, ultimately increasing productivity.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flowchart of a method for managing virtual team collaboration meetings in accordance with an exemplary embodiment of the present invention;

FIG. 2 is a flowchart of a method for managing virtual team collaboration meetings in accordance with an alternative embodiment of the present invention;

FIG. 3 is a block diagram illustrating the function of components of a virtual scrum tool in accordance with an exemplary embodiment of the present invention;

FIG. 4 is a block diagram illustrating the function of components of a virtual scrum tool in accordance with an alternative embodiment of the present invention;

FIG. 5 is a block diagram illustrating the interaction between a user and a virtual scrum tool in accordance with an exemplary embodiment of the present invention;

FIG. 6 is a block diagram illustrating the interaction between a user and a virtual scrum tool in accordance with an alternative embodiment of the present invention;

FIG. 7 is a block diagram illustrating the interface of a virtual scrum tool in accordance with an exemplary embodiment of the present invention;

FIG. 8 is a block diagram illustrating the interface of a virtual scrum tool in accordance with an exemplary embodiment of the present invention; and

FIG. 9 is a block diagram illustrating the interface to a virtual scrum tool in accordance with an exemplary embodiment of the present invention.

### DETAILED DESCRIPTION OF THE INVENTION

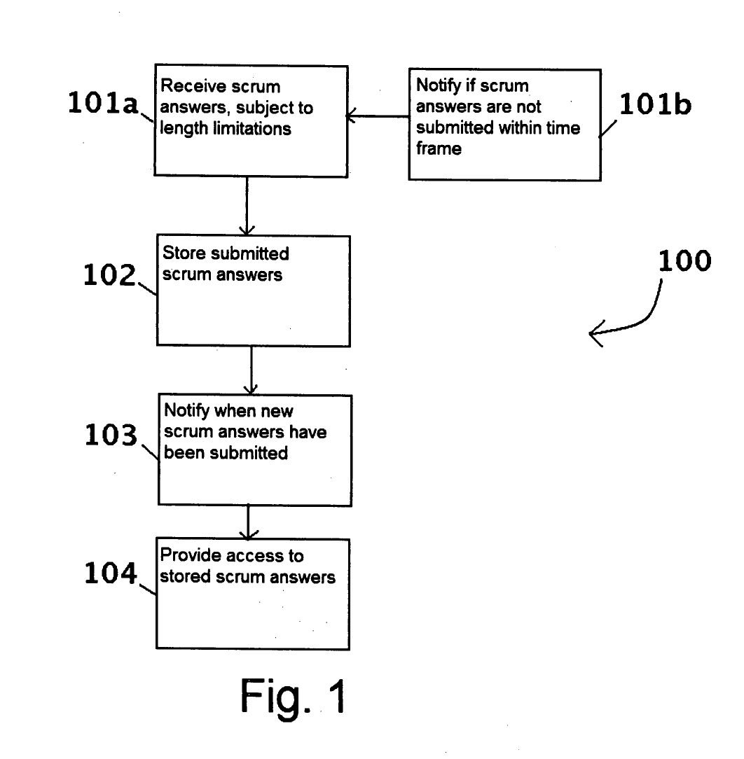

Reference will now be made in detail to the presently preferred embodiments of the invention, examples of which are illustrated in the accompanying drawings. 013 Referring now to FIG. 1, a method for managing virtual team collaboration meetings 100 in accordance with an exemplary embodiment of the present invention is illustrated. In step 101a, answers to scrum questions are received. The answers to scrum questions may be subject to user-defined length limitations. In step 101b, if answers to scrum questions are not received within a user-defined time frame, a reminder notification may be issued. In step 102, received answers to scrum questions are stored. In step 103, a notification may be issued if new answers to scrum questions have been received. In step 104, access is provided to stored answers to scrum questions.

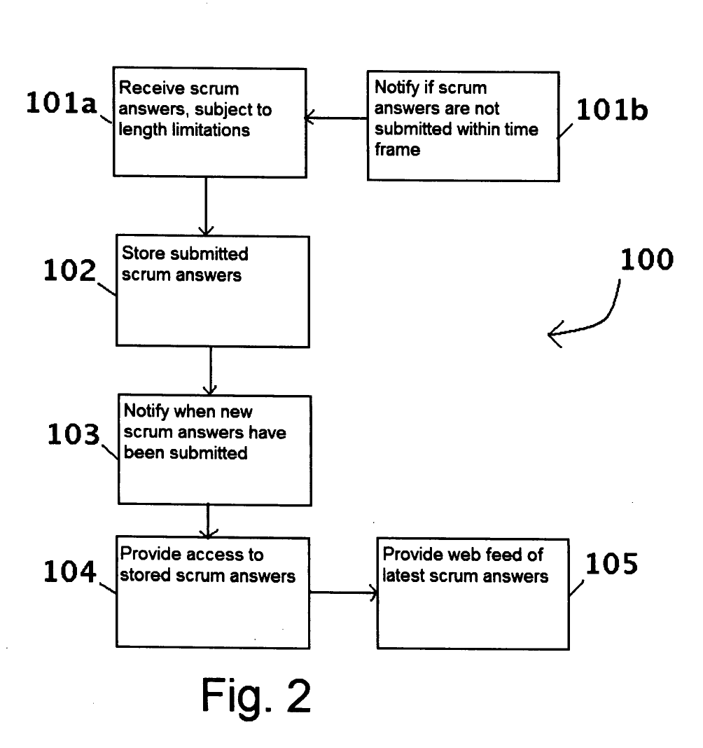

The reminder notification in step 101b may comprise an email. The notification in step 103 may also comprise an email. Referring now to FIG. 2, providing access to stored scrum answers in step 104 may comprise providing a web feed of the latest received scrum answers 105. The web feed may comprise a RSS feed.

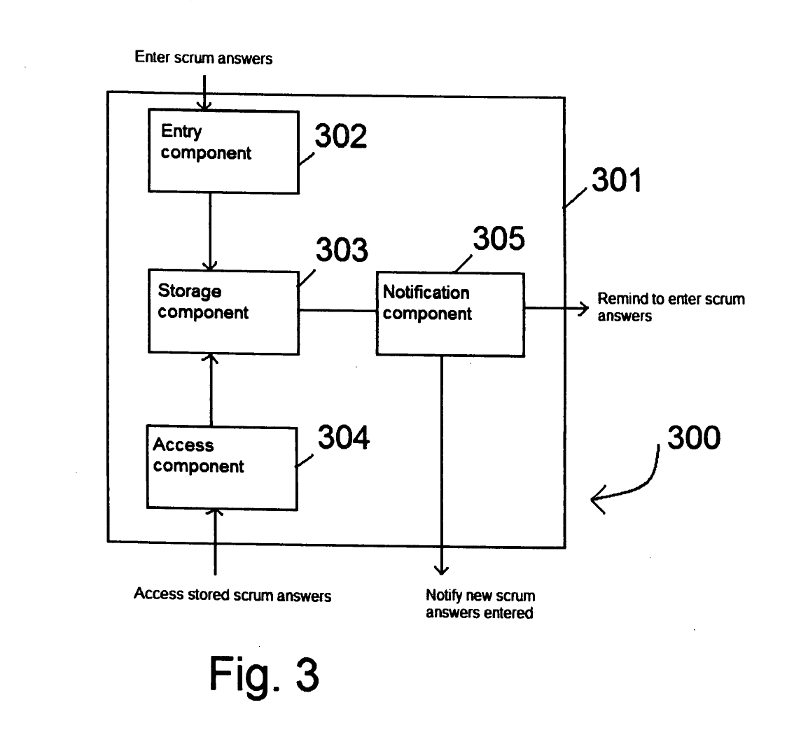

Referring now to FIG. 3, the function 300 of components of a virtual scrum tool 301 in accordance with an exemplary embodiment of the present invention is illustrated. Answers to scrum questions are entered utilizing an entry component 302 of the virtual scrum tool 301. The entry component 302 may comprise a graphical user interface. The answers to scrum questions may be subject to user-defined length limitations. If answers to scrum questions are not entered within a user-defined time frame, the notification component 305 of the virtual scrum tool 301 may issue a reminder notification. The notification component 305 may comprise a software timer. Entered answers to scrum questions are stored by the storage component 303 of the virtual scrum tool 301. The storage component 303 may comprise memory. The notification component 305 of the virtual scrum tool 301 may issue a notification when new answers to scrum questions are entered. Access to answers to scrum questions stored in the storage component 303 is provided by the access component 304 of the virtual scrum tool 301.

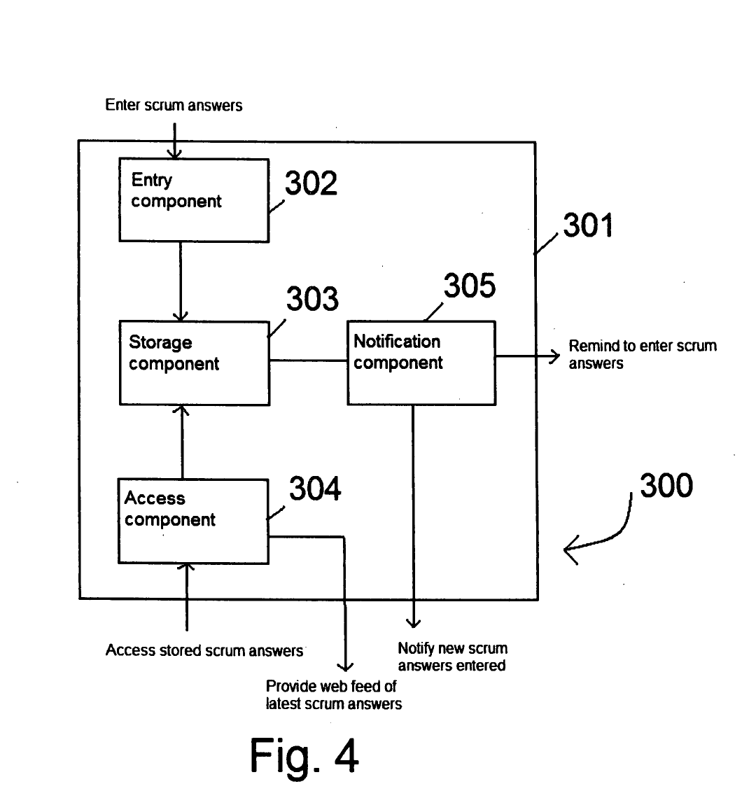

The reminder notification issued by the notification component 305 of the virtual scrum tool 301 may comprise an email. The notification issued by the notification component 305 of the virtual scrum tool 301 may also comprise an email. Now referring to FIG. 4, the access to stored scrum answers provided by the access component 304 of the virtual scrum tool 301 may comprise providing a web feed of the latest received scrum answers. The web feed may comprise a RSS feed.

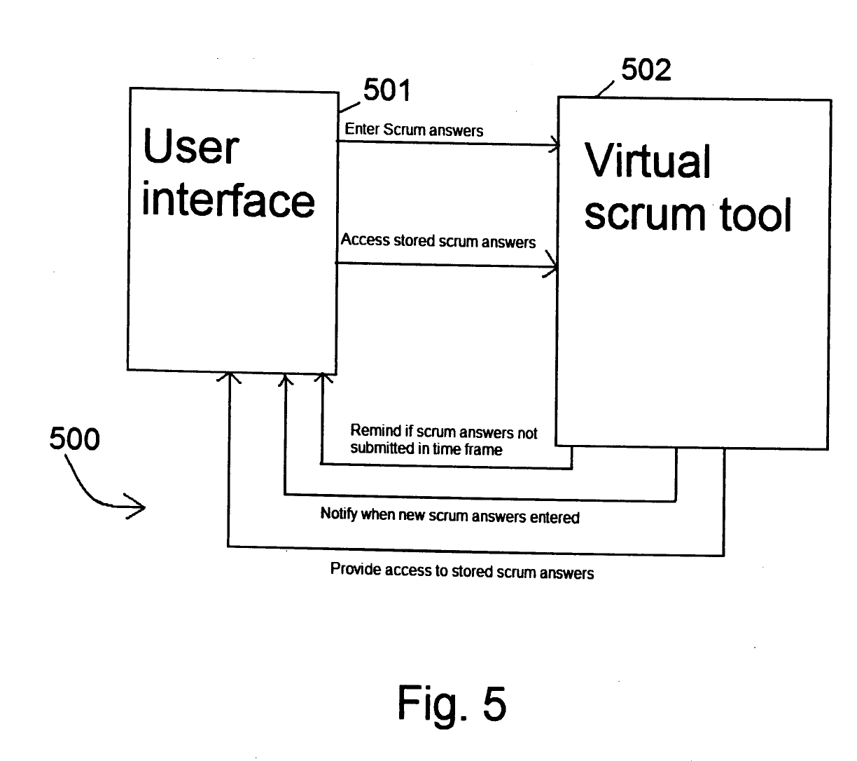

Referring now to FIG. 5, the interaction 500 between a user 501 and a virtual scrum tool 502 in accordance with an exemplary embodiment of the present invention is illustrated. The virtual scrum tool 502 may be implemented as illustrated 300 in FIG. 3. The user 501 enters answers to scrum questions utilizing the virtual scrum tool 502. The answers to scrum questions may be subject to user-defined length limitations. The virtual scrum tool 502 may send a reminder notification to the user 501 if answers to scrum questions are not entered within a user-defined time frame. The virtual scrum tool 502 stores answers to scrum questions that have been entered. The user 501 may access stored answers to scrum questions utilizing the virtual scrum tool 502 which provides access to stored answers to scrum questions.

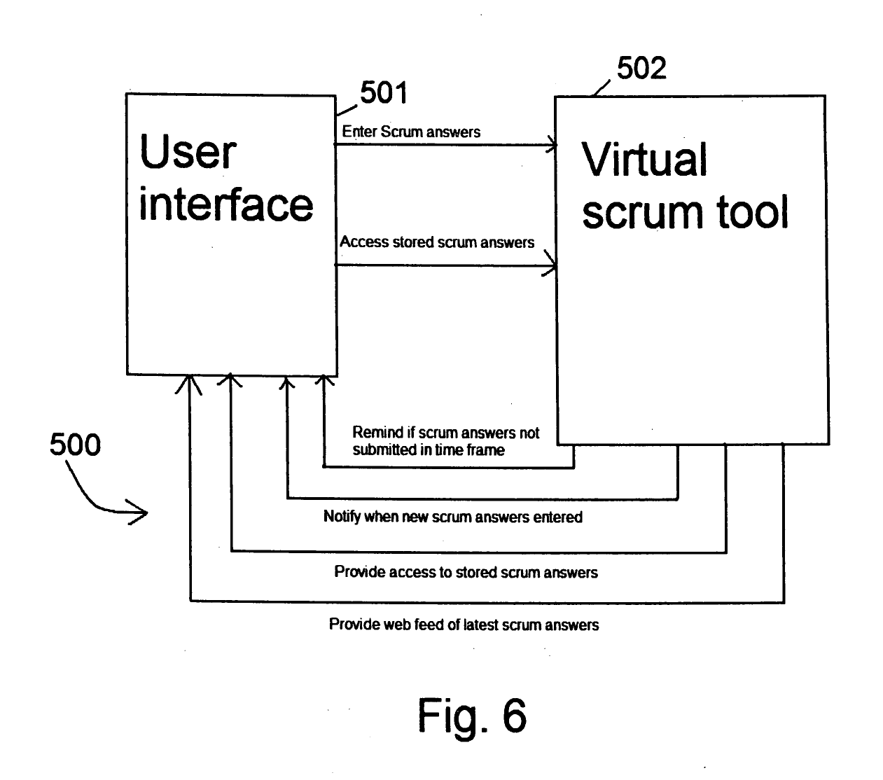

The reminder notification issued by the virtual scrum tool 502 may comprise an email. The notification issued by the virtual scrum tool 502 may also comprise an email. Now referring to FIG. 6, the access to stored scrum answers provided by the virtual scrum tool 502 may comprise providing a web feed of the latest received scrum answers. The web feed may comprise a RSS feed.

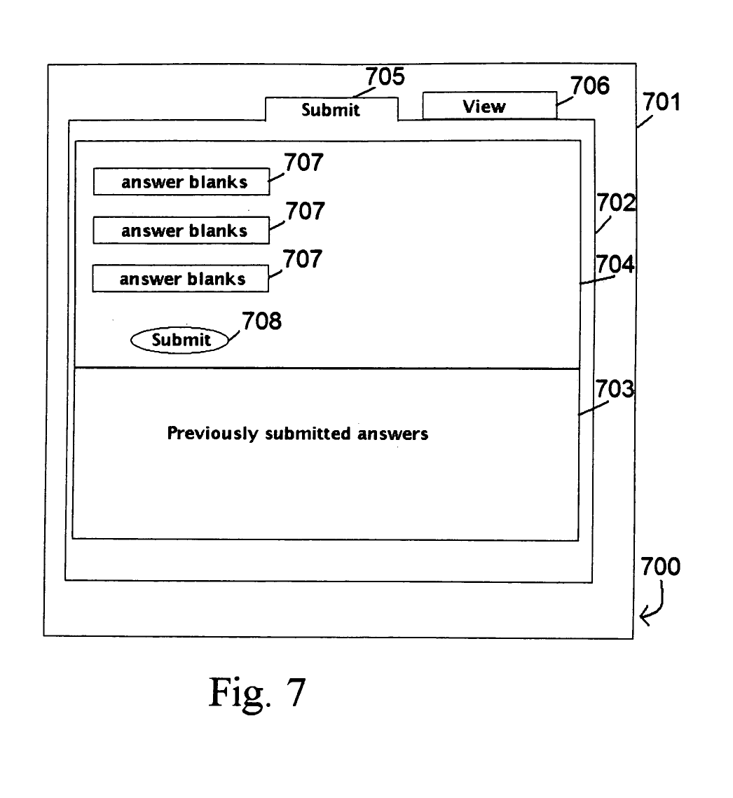

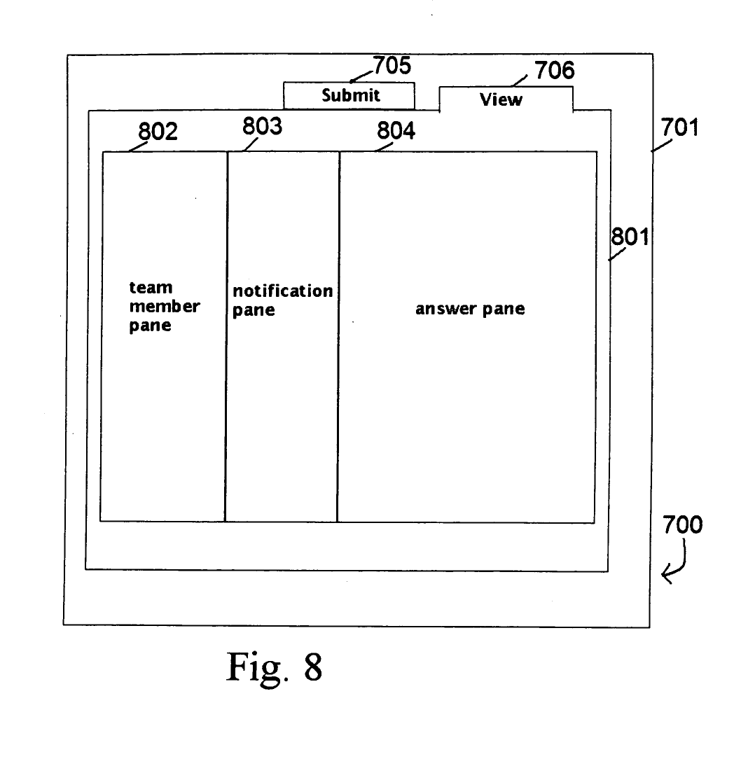

Referring now to FIGS. 7 and 8, an interface 700 of a virtual scrum tool in accordance with an exemplary embodiment of the present invention is illustrated. The virtual scrum tool may be implemented as illustrated 300 in FIG. 3. The interface 700 of the virtual scrum tool may include a graphical user interface 701. The graphical user interface 701 may be a web browser. The graphical user interface 701 may include a submission panel 702 and a view panel 801. The graphical user interface 701 may also include a submission tab 705 and a view tab 706 which a user may utilize to select whether the submission panel 702 or the view panel 801 is selected. Referring now to FIG. 7, the submission panel 702 is illustrated. The submission panel 702 may include a submit pane 704 and a display pane 703. Previously submitted answers may be displayed in the display pane 703. The submit pane 704 may include a number of answer blanks 707 and a submit button 708. A user may submit answers to scrum questions by entering answers into answer blanks 707 and clicking the submit button 708. Referring now to FIG. 8, the view panel 801 is illustrated. The view panel 801 may include a team member pane 802, a notification pane 803, and an answer pane 804. The team member pane 802 may display a list of team members. A user may select one of the team members displayed in the team member pane 802. The notification pane 803 may list the team member or members who will be notified when the team member selected in the team member pane 802 enters answers to scrum questions. The answer pane 804 may display stored answers to scrum questions for the team member selected in the team member pane 802.

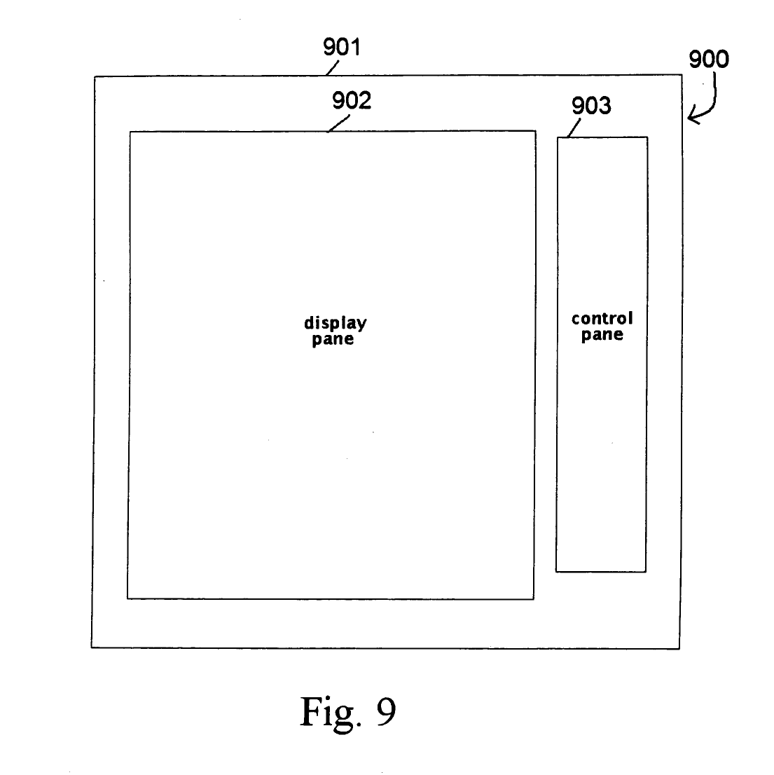

Referring now to FIG. 9, an interface 900 of a virtual scrum tool in accordance with an exemplary embodiment of the present invention is illustrated. The virtual scrum tool may be implemented as illustrated 300 in FIG. 3. The interface 900 may include a graphical user interface 901. The graphical user interface 901 may be a web browser. The graphical user interface 901 may include a display pane 902 and a control pane 903. The display pane 902 may be stored answers to scrum questions supplied by a web feed. The web feed may be an RSS feed. The control pane 903 may allow a user to control how the stored answers to scrum questions are displayed in the display pane 902. A user may be able to utilize the control panel 903 to search stored answers to scrum question displayed in the display pane 902. A user may be able to utilize the control panel 903 to sort the answers to scrum questions displayed in the display pane 902.

It is understood that the present invention is not limited to any underlying implementing technology. The present invention may be implemented utilizing any software development technology including c, c++, java, Perl, PHP, Drupal, basic, or the like. The scrum tool may reside on a user's computer or may reside on a server that a user accesses remotely. A user may utilize a client program to access the present invention implemented to reside on a server. A user may also utilize a web interface to access the present invention implemented to reside on a server. The present invention may be implemented using a variety of software development technologies in a variety of software architectures without departing from the scope and spirit of the invention or without sacrificing all of its material advantages.

It is understood that the specific order or hierarchy of steps in the processes disclosed is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for managing virtual team collaboration meetings, comprising steps of:
receiving answers to questions;
issuing reminders when answers to questions are not submitted within a user-defined time frame;
storing answers to questions that have been submitted;
sending notifications when answers to questions have been submitted; and
providing access to stored answers to questions.

2. The method as claimed in claim 1, wherein the receiving step subjects answers to questions to user-define length limitations.

3. The method as claimed in claim 1, wherein the issuing step comprises an electronic mail message.

4. The method as claimed in claim 1, wherein the sending step comprises an electronic mail message.

5. The method as claimed in claim 1, wherein said providing step comprises a web feed of answers to questions.

6. The method as claimed in claim 5, wherein the web feed comprises the latest answers to questions.

7. The method as claimed in claim 6, wherein said web feed comprises a RSS feed (a web feed format used for Web syndication).

8. A virtual scrum tool comprising:
a data entry means for entering answers to questions;
a first notification means for issuing reminders when answers to questions are not submitted within a user-defined time frame;
a second notification means for sending notifications when answers to questions have been submitted;
a storage means for storing answers to questions; and
an access means for providing access to stored answers to questions.

9. The virtual scrum tool claimed in claim 7, wherein answers to questions are subject to user-define length limitations.

10. The virtual scrum tool claimed in claim 7, wherein the reminder comprises an electronic mail message.

11. The virtual scrum tool claimed in claim 7, wherein the notification comprises an electronic mail message.

12. The virtual scrum tool as claimed in claim 7, wherein the access means includes a web feed of answers to questions.

13. The virtual scrum tool as claimed in claim 12, wherein the web feed comprises the latest answers to questions.

14. The virtual scrum tool as claimed in claim 13, wherein the web feed comprises a RSS feed (a web feed format used for Web syndication).

15. A virtual scrum tool comprising:
an entry component;
a notification component;
a storage component; and
an access component;
wherein the entry component receives answers to questions, the notification component sends reminders when answers to questions are not submitted within a user-defined time frame, the notification component sends notifications when answers to questions have been submitted, the storage component stores answers to questions, and the access component provides access to the stored answers to questions.

16. The virtual scrum tool claimed in claim 7, wherein answers to questions are subject to user-define length limitations.

17. The virtual scrum tool claimed in claim 15, wherein the reminder comprises an electronic mail message.

18. The virtual scrum tool claimed in claim 15, wherein the notification comprises an electronic mail message.

19. The virtual scrum tool as claimed in claim 15, wherein the access means includes a web feed of answers to questions.

20. The virtual scrum tool as claimed in claim 19, wherein the web feed comprises the latest answers to questions.

21. The virtual scrum tool as claimed in claim 20, wherein the web feed comprises a RSS feed (a web feed format used for Web syndication).
